(19) United States
(12) Patent Application Publication
(10) Pub. No.: US 2009/0245580 A1
(43) Pub. Date: Oct. 1, 2009

(54) MODIFYING PARAMETERS OF AN OBJECT DETECTOR BASED ON DETECTION INFORMATION

(76) Inventor: Darryl Greig, Fishponds (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/417,244

(22) Filed: Apr. 2, 2009

Related U.S. Application Data
(63) Continuation-in-part of application No. 11/490,156, filed on Jul. 21, 2006.

(51) Int. Cl. G06K 9/00

(52) U.S. Cl. 382/103

(57) ABSTRACT

Embodiments of an object detection unit configured to modify parameters for one or more object detectors based on detection information are provided.

### CROSS-REFERENCE TO RELATED APPLICATION

This application is a continuation-in-part of U.S. patent application Ser. No. 11/490,156, filed Jul. 21, 2006, and entitled METHOD OF TRACKING AN OBJECT IN A VIDEO STREAM which is incorporated by reference herein in its entirety.

### BACKGROUND

Object detectors are used to identify objects (e.g., faces, cars, and people) in image frames in a video stream. The object detectors are often run with a strategy for sampling the image frames that is designed to handle a broad range of usage scenarios. The strategy may cover a wide range of locations and/or object scales in each image frame in the video stream, for example. Object detectors, however, are often used in circumstances that are more restrictive. In such scenarios, the object detector may search image locations or object scales that are unlikely to occur in a given set of image frames. This unnecessary searching may slow the processing of the image frames and may prevent the object detector from being able to be run at a real-time or near real-time rate (e.g., greater than ten frames per second).

While manual configuration of an object detector may be possible, such efforts may be cumbersome and involve specialized knowledge of the object detector. In addition, the circumstances in which an object detector is used may change over time so that reconfiguration of the object detector may become desirable.

### BRIEF DESCRIPTION OF THE DRAWINGS

FIG. 1 is a block diagram illustrating one embodiment of an image processing environment.

FIGS. 2A-2B are block diagrams illustrating embodiments of sampling grids and scales in an image frame.

FIG. 3A-3B are flow charts illustrating embodiment of methods for adaptively configuring a set of object detectors.

FIG. 4 is a block diagram illustrating one embodiment of an image processing system.

FIG. 5 is a block diagram illustrating one embodiment of an image capture device that includes an image processing system.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, an adaptive object detection unit is provided that adaptively and automatically configures the use of a set of object detectors in processing image frames. The adaptive object detection unit modifies the search parameters of the object detectors based on detection information that identifies previous object detections and/or lack of detections. The search parameters may include parameters that specify a frequency of use of the object detector instance, sizes and/or configurations of sampling grids, a set of object scales to search, and search locations in a set of one or more image frames. During operation, the adaptive object detection unit may increase the use of object detectors with higher likelihoods of detecting objects and decrease the use of object detectors with lower likelihoods of detecting objects, for example. The adaptive object detection unit may select and configure the object detectors to conform to an overall processing constraint of a system that implements the adaptive object detection unit.

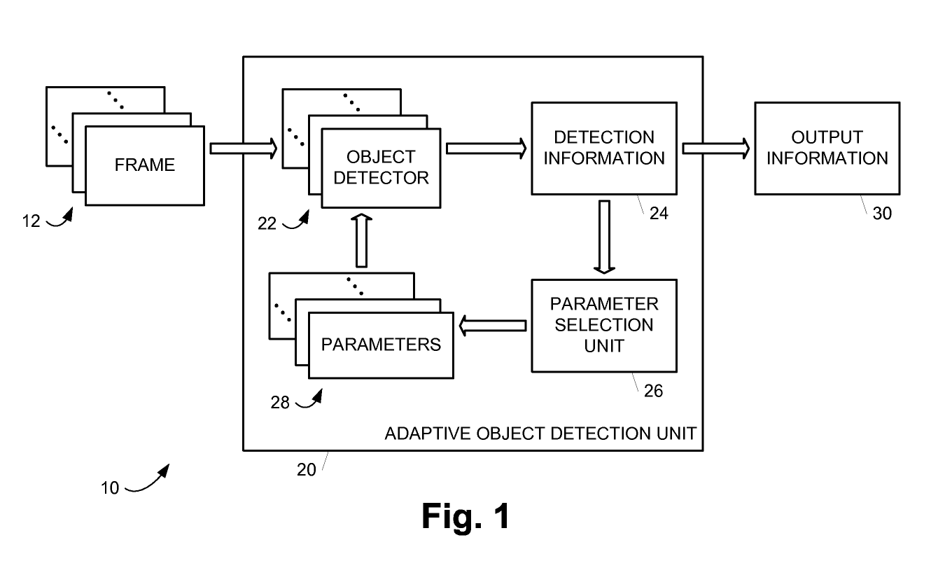

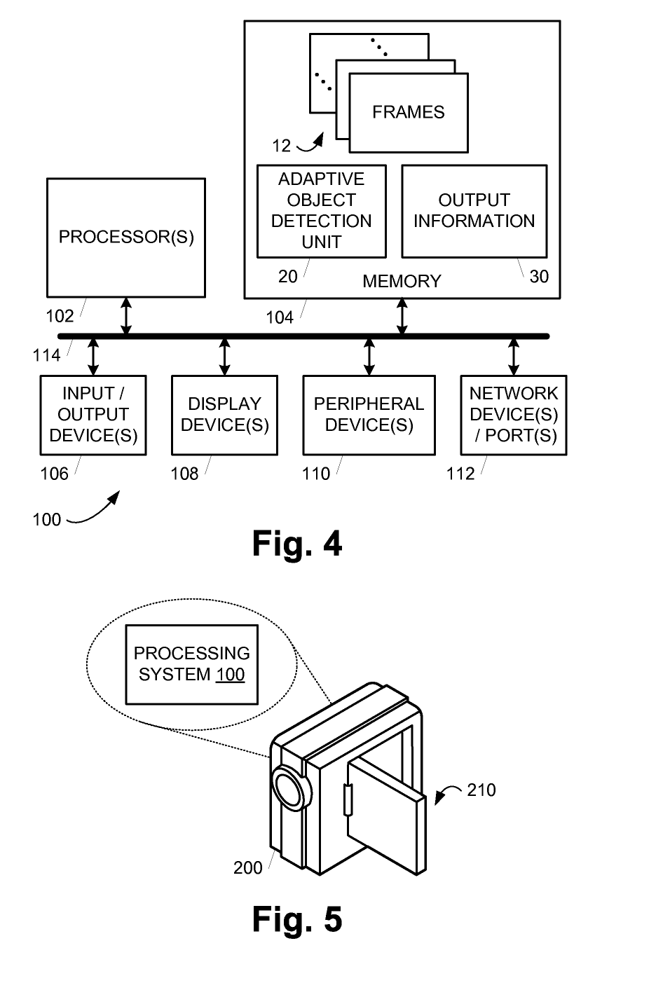

FIG. 1 is a block diagram illustrating one embodiment of an image processing environment 10. Image processing environment 10 represents a runtime mode of operation in an image processing system, such as an image processing system 100 shown in FIG. 4 and described in additional detail below. Image processing environment 10 includes a set of image frames 12, an adaptive object detection unit 20, and output information 30.

The set of frames 12 includes any number of frames 12. Each frame 12 in the set of frames 12 includes information that represents a digital image. Each digital image may be captured by a digital image capture device (e.g., an image capture device 200 shown in FIG. 5 and described in additional detail below), provided from a digital media (e.g., a DVD), converted from a non-digital media (e.g., film) into a digital format, and/or created using a computer graphics or other suitable image generation program. Frames 12 may be displayed by one or more display devices (e.g., one or more of display devices 108 shown in FIG. 4 and described in additional detail below) or other suitable output devices to reproduce the digital image. Each frame 12 may be displayed individually to form a still image or displayed in succession, e.g., 24 or 30 frames per second, to form a video stream. A video stream may include one or more scenes where a scene comprises a continuous set of related frames 12.

Adaptive object detection unit 20 is configured to receive or access frames 12 and cause one or more of a set of object detectors 22 to be run on the set of frames 12 to detect any suitable predefined objects (e.g., faces, cars, and/or people) that may be present in one or more frames 12. The predefined objects may also include variations of the objects such as different poses and/or orientations of the objects. Adaptive object detection unit 20 generates output information 30 that includes the results generated by the set of object detectors 22 in any suitable format. Adaptive object detection unit 20 may provide output information 30 to a user in any suitable way such as providing output information to one or more display devices (e.g., one or more display devices 108 in FIG. 4)

In response to being run, each object detector 22 is configured to receive or access one or more frames 12 and locate one or more predefined objects in frames 12 and store information corresponding to detected objects as detection information 24. The set of object detectors 22 may include any suitable number and/or types of object detectors 22. Each object detector 22 runs in accordance with a corresponding set of parameters 28 that are selected by parameter selection unit 26. Each object detector 22 may include a strategy to locate objects. The strategy may involve pre-processing one or more frames 12 to eliminate locations where objects are not likely to be found.

Detection information 24 identifies each object detected by each object detector 22. For each object detected, detection information 24 may include an identifier of the frame or frames 12 where the object was detected, a copy of the frame 12 or portion of the frame 12 where the object was detected, an identifier of the location or locations in the frame or frames 12 where the object was detected, a type of object (e.g., a face, a car, or a person), an indicator of which object detector 22 detected the object, and the parameters of the object detector 22 that were used in detecting the object. Detection information 24 may be converted into any suitable output format and output as output information 30 by adaptive object detection unit 20.

Parameter selection unit 26 is configured to receive or access detection information 24 and adaptively select a set of parameters 28 for each object detector 22 based on the detection information 24. Parameter selection unit 26 analyzes detection information 24 to determine statistics of object detections and/or lack of object detections for each object detector 22. Parameter selection unit 26 may determine statistics that isolate object detections or lack of detections by one or more parameters 28. Based on the statistics, parameter selection unit 26 identifies object detectors 22 with higher and/or lower likelihoods of detecting objects in frames 12. Parameter selection unit 26 modifies the sets of parameters 28 of object detectors 22 to increase or decrease the amount of searching performed by each object detector 22 based on the likelihoods of detecting objects in frames 12.

Each set of parameters 26 may include one or more parameters that specify a frequency of use of an object detector 22, a size and/or configuration of a sampling grid of an object detector 22, a set of object scales to search with an object detector 22, and/or a set of search locations to search with an object detector 22 in a set of one or more image frames 12. For object detectors 22 configured to search for two or more types of objects, the set of parameters 26 may also include one or more parameters that specify one or more types of objects to be searched.

Parameter selection unit 26 may select a frequency of use of each object detector 22 by setting a rate in which an object detector 22 is to be run. The rate may be specified on a frame basis (e.g., every nth frame where n is an integer), a time basis (e.g., every n seconds), a scene basis (e.g., every n scenes), or on another suitable basis. The rate may be a constant rate or a varying rate.

Parameter selection unit 26 may increase the frequency of use of object detectors 22 with a relatively high number of object detections and may decrease the frequency of use for object detectors 22 with a relatively low number of object detections, for example. An increase in the frequency of use typically increases the processing overhead of an object detector 22, and a decrease in the frequency of use typically decreases the processing overhead of an object detector 22.

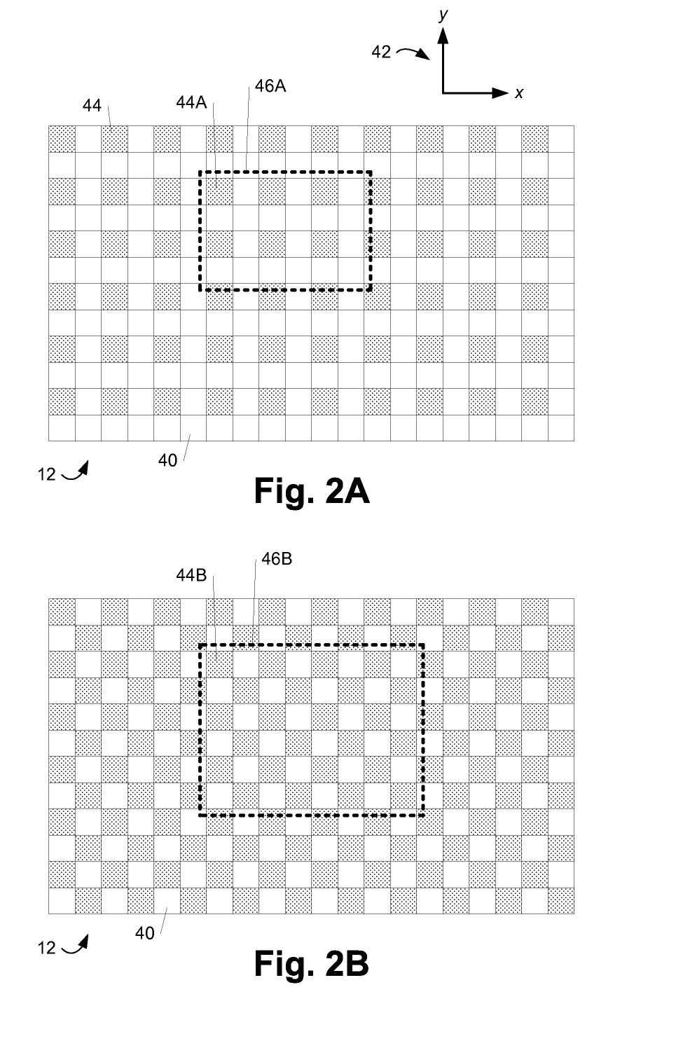

Parameter selection unit 26 may also select a sampling grid for each object detector 22 as illustrated with reference to FIGS. 2A-2B. The sampling grid refers to the set of sample locations to be searched by an object detector 22. As shown in FIG. 2A, each frame 12 includes an array of pixel locations 40 with corresponding pixel values. The array may be arranged in rows and columns where an x coordinate identifies a column and a y coordinate identifies a row as indicated by a legend 42 or in other suitable pixel arrangements. In the example of FIG. 2A, the sampling grid includes the shaded sample locations 44 which cover one-fourth of the pixel locations in frame 12. In the example of FIG. 2B, the sampling grid includes the shaded sample locations 44 which cover one-half of the pixel locations in frame 12. In other examples, other sampling grids may have other sample resolutions. The sampling grids selected by parameter selection unit 26 may range from coarse, where a relatively small percentage of pixel locations are searched, to fine, where a relatively high percentage of pixel locations are searched.

Parameter selection unit 26 may specify the sampling grid of each frame 12 by specifying search location increments in the x and y directions. For example, parameter selection unit 26 may specify increments of two pixels in both the x and y directions to produce the sampling grid of FIG. 2A. Likewise, parameter selection unit 26 may specify an increment of two pixels in the x direction (where the first pixel searched in each row is staggered) and an increment of one pixel in the y direction to produce the sampling grid of FIG. 2B. Parameter selection unit 26 may cause a sampling grid to be shifted by one or more pixels in the x and/or y directions between each frame 12 by alternating a starting pixel over a set of frames. By doing so, the entire sample space may be covered over a given number of frames, depending on the size of the sampling grid. For example, the sampling grid in FIG. 2B may be shifted by one pixel in either the x or the y direction to cover the entire sample space of frame 12 over two frames 12.

Parameter selection unit 26 may increase the sampling resolution of a sampling grid for object detectors 22 with a relatively high number of object detections and may decrease the sampling resolution of a sampling grid for object detectors 22 with a relatively low number of object detections, for example. An increase in the sampling resolution of a sampling grid typically increases the processing overhead of an object detector 22, and a decrease in the sampling resolution of a sampling grid typically decreases the processing overhead of an object detector 22.

Parameter selection unit 26 may further select a set of object scales for each object detector 22 as illustrated with reference to FIGS. 2A-2B. An object scale refers to the size of the set of pixels used to search for an object at each sample location. The set of scales may includes a range of object scales with different sizes. An object scale 46A for a sample location 44A is shown in FIG. 2A. In this example, object scale 46A is indicated by the dotted line that encloses the set of six by four pixels for sample location 44A. In FIG. 2B, an object scale 46B for a sample location 44B is shown in FIG. 2B. In this example, object scale 46B is indicated by the dotted line that encloses the set of eight by six pixels for sample location 44B.

Parameter selection unit 26 may increase the number of object scales in the set of object scales for object detectors 22 with a relatively high number of object detections and may decrease the number of object scales in the set of object scales for object detectors 22 with a relatively low number of object detections, for example. More particularly, parameter selection unit 26 may increase the number of object scales by including object scales that are near one or more object scales where objects were detected as indicated in detection information 24. Likewise, parameter selection unit 26 may decrease the number of object scales by removing object scales that are near one or more object scales where objects were not detected as indicated in detection information 24. An increase in the number of object scales typically increases the processing overhead of an object detector 22, and a decrease in the number of object scales typically decreases the processing overhead of an object detector 22.

In addition, parameter selection unit 26 may select a set of search locations to search with an object detector 22 in a set of one or more image frames 12. In analyzing detection information 24, parameter selection unit 26 may determine that some portions of image frames 12 have a relatively high number of object detections and that other portions have a relatively low number of object detections. Accordingly, parameter selection unit 26 may ensure that the set of search locations include the portions that have a relatively high number of object detections and exclude the portions that have a relatively low number of object detections. An increase in the set of search locations typically increases the processing overhead of an object detector 22, and a decrease in the set of search locations typically decreases the processing overhead of an object detector 22.

Parameter selection unit 26 may further select one or more types of object to be searched for object detectors 22 configured to search for two or more kinds of objects. In analyzing detection information 24, parameter selection unit 26 may determine that some types of objects have a relatively high number of object detections and that other types of objects have a relatively low number of object detections for an object detector 22.

Parameter selection unit 26 may increase the amount of searching with object types of object detectors 22 with relatively high numbers of object detections and may decrease the amount of searching with object types of object detectors 22 with a relatively low number of object detections, for example. An increase in the amount of searching with one or more object types typically increases the processing overhead of an object detector 22, and a decrease in the amount of searching with one or more object types typically decreases the processing overhead of an object detector 22.

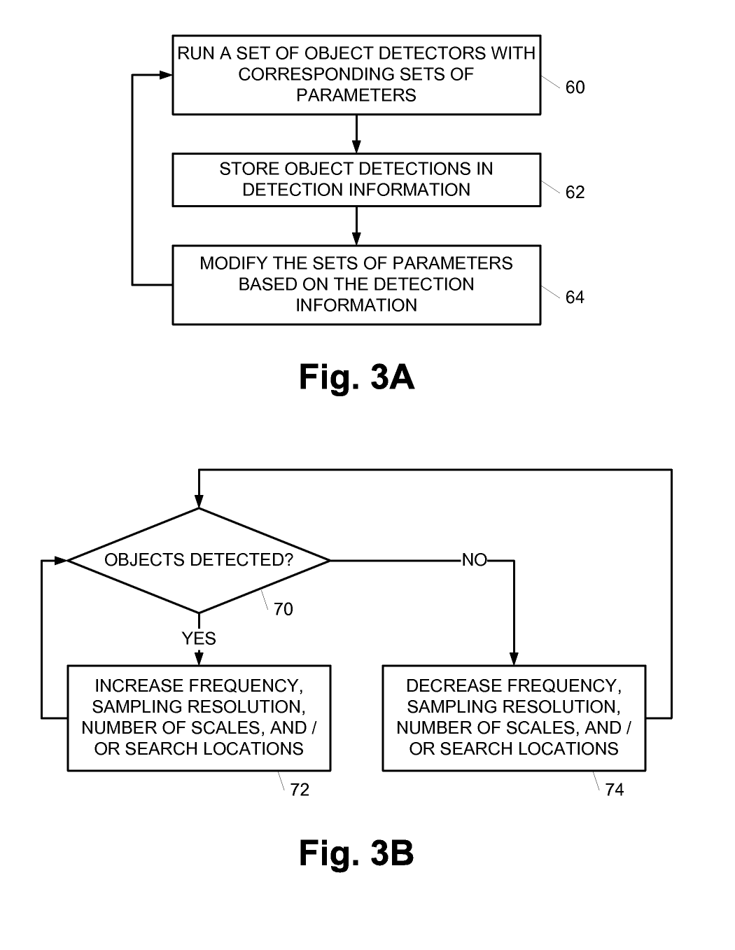

FIG. 3A-3B are flow charts illustrating embodiment of methods for adaptively configuring a set of object detectors 22 as performed by adaptive object detection unit 20.

In FIG. 3A, adaptive object detection unit 20 runs a set of one or more object detectors 22 with corresponding sets of parameters 28 as indicated in a block 60. The sets of parameters 28 may each be a set of default parameters initially where the default parameters are set by a user, developers of the object detectors, or adaptive object detection unit 20. Adaptive object detection unit 20 may run the set of object detectors 22 simultaneously on the same set of one or more frames 12 or may stagger or serialize the execution of the set of object detectors 22 over the same or different sets of frames 12.

Each object detector 22 stores object detections in detection information 24 as indicated in a block 62. Adaptive object detection unit 20 receives or accesses the detection information 24 and modifies the set of parameters 28 for the set of object detectors 22 based on the detection information 24 as indicated in a block 64. Parameter selection unit 26 may make the modifications continuously, periodically, and/or in response events such as detecting an object or completing a search of a frame 12. Adaptive object detection unit 20 repeats the function of block 60 to runs a set of one or more object detectors 22 with corresponding modified sets of parameters 28 as shown in FIG. 3A.

Adaptive object detection unit 20 may modify any number of parameters in the set of parameters 28 for each object detector 22 in response to the detection information 24 as illustrated in FIG. 3B. Adaptive object detection unit 20 may perform the method of FIG. 3B for each object detector 22 individually. In analyzing detection information 24, adaptive object detection unit 20 determines whether objects were detected with an object detector 22 as indicated in a block 70. If so, then adaptive object detection unit 20 modifies the set of parameters 28 for the object detector 22 to increase the frequency of use, sampling resolution, number of object scales, and/or search locations as indicated in a block 72. If not, then adaptive object detection unit 20 modifies the set of parameters 28 for the object detector 22 to decrease the frequency of use, sampling resolution, number of object scales, and/or search locations as indicated in a block 74.

In addition to modifying the sets of parameters 28 for each object detector 22 individually, adaptive object detection unit 20 may also modify the sets of parameters 28 collectively to fit within one or more processing constraints of an image processing system (e.g., image processing system 100 of FIG. 4) that implements adaptive object detection unit 20. Adaptive object detection unit 20 may detect or receive information that describes processing overheads of the set of object detector 22 for various sets of parameters 28. Adaptive object detection unit 20 uses the overhead information to set and modify the sets of parameters 28 to ensure that the set of object detectors 22 run within the processing constraints. For example, adaptive object detection unit 20 may set and modify the sets of parameters 28 to ensure that the set of object detectors 22 run at real-time or near-real time object detection rates.

FIG. 4 is a block diagram illustrating an embodiment of image processing system 100 which is configured to implement image processing environment 10 as shown in FIG. 1.

Image processing system 100 includes one or more processors 102, a memory system 104, zero or more input/output devices 106, zero or more display devices 108, zero or more peripheral devices 110, and zero or more network devices and/or ports 112. Processors 102, memory system 104, input/output devices 106, display devices 108, peripheral devices 110, and network devices 112 communicate using a set of interconnections 114 that includes any suitable type, number, and configuration of controllers, buses, interfaces, and/or other wired or wireless connections.

Image processing system 100 represents any suitable processing device configured for a specific purpose or a general purpose. Examples of image processing system 100 include an image capture device (e.g., a digital camera or a digital camcorder), a server, a personal computer, a laptop computer, a tablet computer, a personal digital assistant (PDA), a mobile telephone, and an audio/video device. The components of image processing system 100 (i.e., processors 102, memory system 104, input/output devices 106, display devices 108, peripheral devices 110, network devices 112, and interconnections 114) may be contained in a common housing (not shown) or in any suitable number of separate housings (not shown).

Processors 102 are configured to access and execute instructions stored in memory system 104. Processors 102 are also configured to access and process data stored in memory system 104. The instructions include adaptive object detection unit 20 in one embodiment. The instructions may also include a basic input output system (BIOS) or firmware (not shown), device drivers, a kernel or operating system (not shown), a runtime platform or libraries (not shown), and applications (not shown). The data includes frames 12 and output information 30. Each processor 102 may execute the instructions in conjunction with or in response to information received from input/output devices 106, display devices 108, peripheral devices 110, and/or network devices/ports 112.

Memory system 104 includes any suitable type, number, and configuration of storage devices configured to store instructions and data. The storage devices of memory 104 may include volatile or non-volatile storage devices and/or portable or non-portable storage devices. The storage devices represent computer readable media that store computer-executable instructions including adaptive object detection unit 20 and data including frames 12 and output information 30. Memory system 104 stores instructions and data received from processors 102, input/output devices 106, display devices 108, peripheral devices 110, and network devices/ports 112. Memory system 104 provides stored instructions and data to processors 102, input/output devices 106, display devices 108, peripheral devices 110, and network devices 112. The instructions are executable by image processing system 100 to perform the functions and methods of adaptive object detection unit 20 described herein. Examples of storage devices in memory system 104 include hard disk drives, random access memory (RAM), read only memory (ROM), flash memory drives and cards, and magnetic and optical disks.

Input/output devices 106 include any suitable type, number, and configuration of input/output devices configured to input instructions or data from a user to image processing system 100 and output instructions or data from image processing system 100 to the user. Examples of input/output devices 106 include a keyboard, a mouse, a touchpad, a touchscreen, buttons, dials, knobs, and switches.

Display devices 108 include any suitable type, number, and configuration of display devices configured to output image, textual, and/or graphical information to a user of image processing system 100. Examples of display devices 108 include a monitor, a display screen, and a projector.

Peripheral devices 110 include any suitable type, number, and configuration of peripheral devices configured to operate with one or more other components in image processing system 100 to perform general or specific processing functions.

Network devices/ports 112 include any suitable type, number, and configuration of network devices and/or ports configured to allow image processing system 100 to communicate across one or more networks (not shown) or with one or more additional devices (not shown). Network devices 112 may operate according to any suitable networking protocol and/or configuration to allow information to be transmitted by image processing system 100 to a network or received by image processing system 100 from a network. Any additional devices may operate according to any suitable port protocol and/or configuration to allow information to be transmitted by image processing system 100 to a device or received by image processing system 100 from a device.

In one embodiment, image processing system 100 is included in an image capture device 200 that captures, stores, and processes frames 12 as shown in the embodiment of FIG. 5. Image capture device 200 may display output information 30 to a user using an integrated display device 210. In other embodiments, image processing system 100 receives frames 12 from another image capture device and/or storage media and processes frames 12 as described above.

With the above embodiments, a full search of a video stream may be continually maintained with any suitable number of object detectors while remaining within any processing constraints of an image processing system. Processing resources of the system may be focused on searching with configurations of object detectors that have high likelihoods of object detections. As a result, a suite of object detectors may be automatically and adaptively configured for use in a wide variety of applications.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A method performed by a processing system, the method comprising:
running a first object detector on a first image frame with a first set of parameters to generate first detection information;
modifying the first set of parameters of the first object detector in response to the first detection information; and
subsequent to modifying the first set of parameters, running the first object detector with the first set of parameters on a second image frame.

2. The method of claim 1 further comprising:
modifying the first set of parameters to modify an amount of searching by the first object detector in response to the first detection information.

3. The method of claim 1 further comprising:
running a second object detector on the first image frame with a second set of parameters to generate second detection information;
modifying the second set of parameters of the second object detector in response to the second detection information; and
subsequent to modifying the second set of parameters, running the second object detector with the second set of parameters on the second image frame.

4. The method of claim 1 further comprising:
detecting a first object in the first image frame with the first object detector; and
storing the first set of parameters and an indication of the first object in the first detection information.

5. The method of claim 1 further comprising:
modifying a frequency of use of the first object detector in response to the first detection information.

6. The method of claim 1 further comprising:
modifying a sampling grid of the first object detector in response to the first detection information.

7. The method of claim 1 further comprising:
modifying a set of object scales of the first object detector in response to the first detection information.

8. The method of claim 1 further comprising:
modifying a set of search locations of the first object detector in response to the first detection information.

9. The method of claim 1 further comprising:
ensuring that the first set of parameters are configured to remain within a processing constraint.

10. A system comprising:
a memory including an object detection unit with a first object detector, a video stream, and detection information; and
a processor configured to execute the object detection unit to:
access first detection information that identifies a first set of objects detected in a first portion of a video stream by a first object detector with a first set of parameters;
modify the first set of parameters using the first detection information; and
subsequent to modifying the first set of parameters, run the first object detector with the first set of parameters on a second portion of the video stream that is subsequent to the first portion.

11. The system of claim 10, wherein the processor is configured to execute the object detection unit to:
determine a likelihood of detecting the first set of objects in the second portion of the video stream with the first object detector from the first detection information; and
modify the first set of parameters in response to the likelihood.

12. The system of claim 11, wherein the processor is configured to execute the object detection unit to:
increase an amount of searching by the first object detector in response to the likelihood being relatively high.

13. The system of claim 11, wherein the processor is configured to execute the object detection unit to:
decrease an amount of searching by the first object detector in response to the likelihood being relatively low.

14. The system of claim 10, wherein the processor is configured to execute the object detection unit to:
access second detection information that identifies a second set of objects detected in the first portion of the video stream by a second object detector with a second set of parameters;
modify the second set of parameters using the second detection information; and
subsequent to modifying the second set of parameters, run the second object detector with the second set of parameters on the second portion of the video stream that is subsequent to the first portion.

15. The system of claim 10, wherein the processor is configured to execute the object detection unit to:
determine processing constraint of the system; and
modify the first and the second sets of parameters to remain within the processing constraint.

16. A computer readable storage medium storing computer-executable instructions that, when executed in a scheduler of a process of a computer system, perform a method comprising:
detecting a processing constraint of the computer system; and
setting a first set of parameters of a first object detector to cause the first object detector to search for a first object in a video stream within the processing constraint.

17. The computer readable storage medium of claim 16, the method further comprising:
setting a second set of parameters of a second object detector to cause the second object detector to search for a second object in the video stream within the processing constraint.

18. The computer readable storage medium of claim 16, the method further comprising:
running the first object detector on a first portion of the video stream to generate detection information;
modifying the first set of parameters of the first object detector in response to the detection information and the processing constraint; and
subsequent to modifying the first set of parameters, running the first object detector with the first set of parameters on a second portion of the video stream.

19. The computer readable storage medium of claim 18, the method further comprising:
modifying the first set of parameters to modify an amount of searching by the first object detector in response to the detection information and the processing constraint.

20. The computer readable storage medium of claim 19, the method further comprising:
detecting a first object in the first portion with the first object detector; and
storing the first set of parameters and an indication of the first object in the detection information.
